(19) United States
(12) Patent Application Publication
(10) Pub. No.: US 2026/0201939 A1
(43) Pub. Date: Jul. 16, 2026

(54) CONVEYOR BELT AND METHOD FOR CLOSING A CONVEYOR BELT

(71) Applicant: MAFDEL, Saint-Georges-d’Espéranche (FR)

(72) Inventor: François-Régis JOUFFRAY, Culin (FR)

(73) Assignee: MAFDEL, Saint-Georges-d’Espéranche (FR)

(21) Appl. No.: 19/136,659

(22) PCT Filed: Dec. 8, 2023
(86) PCT No.: PCT/EP2023/084993

§ 371 Date: Jun. 6, 2025

(30) Foreign Application Priority Data
Dec. 9, 2022 (FR) FR2213127
Dec. 9, 2022 (FR) FR2213129

(51) Int. Cl. F16G 3/04; B65G 15/32

(52) U.S. Cl. CPC F16G 3/04; B65G 15/32

(57) ABSTRACT

A conveyor belt includes first and second ends defining clips with series of holes. To close the conveyor belt, the clips are arranged alternately with the series of holes facing one another to form a through hole. The pin is formed by a first part and a second part that are both terminated by an annular button. The two parts pass through the holes and join one another in a single clip.

### DESCRIPTION

### Background of the Invention

The invention relates to a conveyor belt and to a method for closing a conveyor belt.

### Prior Art

For transporting products, it is known to use conveyors having a conveyor belt. The conveyor belt can be an openable band, i.e. a band the two opposite ends of which are joined to define a ring as illustrated in the document US2012/0217139. This document illustrates a closing system having a series of rings at each end. The two series of rings can be connected by a U-shaped connector each wing of which is inserted in one of the series of rings. The configuration of the closing system seems incompatible with use for transporting foodstuffs that will be able to become stuck in the closing system.

It is also known from the document U.S. Pat. No. 5,662,211 to connect the two ends of the conveyor belt by a single hinge pin that is inserted in a hole. The hole is defined by first clips formed at a first end of the conveyor belt and by second clips formed at the opposite end. This configuration allows the first clips to swivel considerably with respect to the second clips, which is detrimental to good control of bacterial proliferation when transporting foodstuffs. Furthermore, the hinge pin is made up in two parts and is designed to be fixed entirely in the band of the conveyor. The band defines cavities enabling deformable arms arranged at the ends of the hinge pin to deviate into the cavities to prevent undesired departing of the parts of the hinge pin.

To transport products, for example food products, it is known to use conveyors equipped with bands. The bands are generally made from polymer material.

As illustrated in the document US 2009/0301845, the band of the conveyor comes in the form of an openable ring, i.e. the first end and second end of the band are separable. To open and close the band, it is known to form a series of clips at each end. The two series of clips are arranged alternately to close the band, and they define a series of holes at the first end and a series of holes at the second end. The two series of holes are arranged facing one another and a pin passes alternately through the holes of the first end and second end. The pin prevents the two ends from coming detached from one another. Depending on the configurations, the pin is installed in removable or irremovable manner.

The conveyor belt is driven by means of a drive wheel. The conveyor belt deforms to follow the curvature imposed by the drive wheel. Closing of the conveyor belt by two series of clips passed through by a securing pin results in formation of a textured area with gaps conducive to impurities entering therein that are difficult to clean. In the food sector, it is particularly important for the conveyor belt to be as neutral as possible as regards the foods it transports, and in particular for it not to be the cause of bacterial contamination.

The use of a single through hole of circular cross-section induces formation of a pivot point between the two series of clips that deform differently and allow foodstuffs to enter between the two clips, which is detrimental to satisfactory operation of the conveyor. To reduce this phenomenon, it is proposed to use a through hole and a securing pin that do not present a circular cross-section. This configuration is difficult to implement and does not provide a satisfactory result.

In the same document, it is known to form a first end and a second end of a conveyor belt defining two series of holes designed to face one another to close the conveyor belt. The two through holes are filled by two pins. The two holes are made inside two teeth that perform driving of the conveyor belt.

There again, it is apparent that the functioning observed is not optimal as the portion delineated by the two pins deforms differently from the rest of the conveyor belt complicating operation of the accessories, in particular the scrapers. It is also apparent that the connection between the two ends of the openable band is rapidly contaminated by bacteria originating from the foodstuff stuck in the closing area.

In one embodiment, several pins are inserted in one and the same through hole, implying formation of a very incomplete filling of the cross-section of the through hole and therefore formation of an empty area that may store impurities.

In another embodiment, a pin is inserted in the through hole and then cut to the width of the conveyor belt. Adjustment of the length of the pin to the width of the conveyor belt is approximate resulting in the connection between the pin and the side wall being an area conducive to bacterial contamination.

It is also known to install the pin in the through hole and to then melt the ends of the pin to make the pin irremovable. The shape of the molten bead is not well mastered resulting in the molten bead presenting a random shape with concavities that are difficult to clean that is not propitious to good control of bacterial contamination.

### Object of the Invention

One object of the invention consists in providing a conveyor belt that enables a closing area to be formed presenting a mechanical behaviour close to the mechanical behaviour outside the closing area, and wherein the bacterial contamination related to the closing area is better controlled than in the prior art configuration, while enabling the closing device to be disassembled easily to perform cleaning if required.

This problem tends to be overcome by means of a conveyor belt comprising:
a first end defining first clips with at least a first series of holes having a first diameter;
a second end defining second clips with at least a first series of holes having the first diameter, and in a closed position of the belt of the conveyor, the first clips and second clips form an alternation and the first series of holes are aligned to form a first through hole extending over a whole width of the conveyor belt;
a first pin passing through the first series of holes to secure the first end and second end, the first pin being removable with respect to the first end and second end.

The closing device is remarkable in that the first pin is formed by means of a first part and a second part that each comprise an end-of travel stop determining the maximum depression of each of the first part and second part in the first through hole.

Each end-of travel stop forms a button defining a continuous annular contact area with a lateral face of one of the first and second clips around the two ends of the first through hole. The first part and second part join one another inside one and the same clip of the first clips and second clips.

In advantageous manner, the first part defines an empty area with the second part inside said clip.

In a particular configuration, a thickness of the end-of travel stop is at least 10% greater than the first diameter and smaller than a mean thickness of the first clip and second clip.

Preferentially, the closing device of a conveyor belt only comprises a first pin. The clip receives the end of the first part, and the end of the second part is located in a central third in a transverse direction.

According to one embodiment, the closing device of an openable conveyor belt comprises a first pin and a second pin offset in a longitudinal direction of the conveyor belt. The first pin and the second pin are both formed in two parts. The clip receiving the end of the first part and the end of the second part of the first pin located in a first third in a transverse direction is different from the clip receiving the end of the first part and the end of the second part of the second pin.

According to another embodiment, the closing device of an openable conveyor belt comprises a first pin and a second pin offset in a longitudinal direction of the conveyor belt. The first pin and the second pin are each formed in two parts. The end-of travel stop of the first part of the first pin is monolithic with the end-of travel stop of the first part of the second pin to form a strengthener having a thickness that is greater than or equal to the mean diameter of the first pin and the second pin and smaller than the thickness of the first clips and second clips at least between the first pin and the second pin.

It is a further object of the invention to provide a conveyor belt that has a closing device, the bacterial contamination of which related to the pin is better mastered than in the prior art configuration while enabling the closing device to be disassembled easily to facilitate cleaning of the latter if necessary.

This result tends to be achieved by means of a conveyor belt comprising a closing device according to any one of the above configurations.

It is yet a further object of the invention to provide a method for closing a conveyor belt that is easier to use than the belts of the prior art and that improves control of bacterial contamination.

This result tends to be achieved by means of a method for closing a conveyor belt that comprises:
providing a conveyor belt provided with a first end defining first clips with at least a first series of holes having a first diameter and with a second end defining second clips with at least a first series of holes having the first diameter,
closing the conveyor belt, the first clips and the second clips forming an alternation and the first series of holes being aligned to form a first through hole extending over a whole width of the conveyor belt;
inserting a first part of a first pin passing through the first series of holes to secure the first end and the second end, the first part of the first pin being removable with respect to the first end and the second end, the first part of the first pin terminating in a clip of the first clips and the second clips;
inserting a second part of the first pin passing through the first series of holes to secure the first end and the second end, the second part of the first pin being removable with respect to the first end and the second end, the second part of the first pin terminating in said clip of the first clips and second clips.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a conveyor provided with a conveyor belt and a drive wheel;

FIG. 2 schematically illustrates a perspective view of a closing device of a conveyor belt according to the invention;

FIG. 3 schematically illustrates a longitudinal sectional view of a clip of a closing device, the conveyor belt being open;

FIG. 4 schematically illustrates a top view of an embodiment of a closing device in the closed position;

FIG. 5 schematically illustrates a side view of a closing device in the closed position;

FIG. 6 schematically illustrates a perspective view of one end of a conveyor belt with a series of clips;

FIG. 7 schematically illustrates a sectional view of an embodiment of a closing device in the closed position, the pins being made up in two parts;

FIG. 8 schematically illustrates a top view of two pins in the course of insertion in the clips of the closing device;

FIG. 9 schematically illustrates a perspective view of a closing device of a conveyor belt deformed to follow the curvature of a wheel, the closing device being in the open position;

FIG. 10 schematically illustrates a perspective view in the inner face of one end of a conveyor belt;

FIG. 11 schematically illustrates a perspective view of a closing device of a conveyor belt deformed to follow the curvature of a wheel, the closing device being in the closed position, the pins being partially extracted;

FIG. 12 schematically illustrates a perspective view of the closing device in contact with a wheel;

FIG. 13 schematically illustrates a sectional view of the closing device with the pins depressed, a pin being made up in two parts;

FIG. 14 schematically illustrates a sectional view of the closing device with the pins depressed, a pin being made up in two parts, the pins being provided with a blocker;

FIG. 15 schematically illustrates a perspective view of two pins connected by a strengthener;

FIG. 16 schematically illustrates a sectional view of a closing device of a conveyor belt rotating around a cog-wheel;

FIG. 17 schematically illustrates a perspective view of a closing device rotating around a cog-wheel and in contact with a scraper;

FIG. 18 schematically illustrates a perspective view of a closing device deformed to follow the curvature of a cog-wheel, the closing device being offset from the cog-wheel to illustrate the organisation of the clips;

FIG. 19 schematically illustrates a side view of another embodiment of a closing device of a conveyor belt rotating around a cog-wheel and in contact with a scraper;

FIG. 20 schematically illustrates a perspective view of a closing device provided with a single pin with an annular end-of travel stop;

FIG. 21 schematically illustrates a perspective view of the closing device of FIG. 20, the pin being partially extracted;

FIG. 22 schematically illustrates a sectional view of the closing device of FIG. 20;

FIG. 23 schematically illustrates a sectional view of the closing device of FIG. 20, the pin being made up in two parts that join one another in the same clip;

FIG. 24 schematically illustrates a sectional view of the closing device of FIG. 20, the pin being made up in two parts that join one another in the same clip in the median position in the widthwise direction.

### DESCRIPTION OF THE EMBODIMENTS

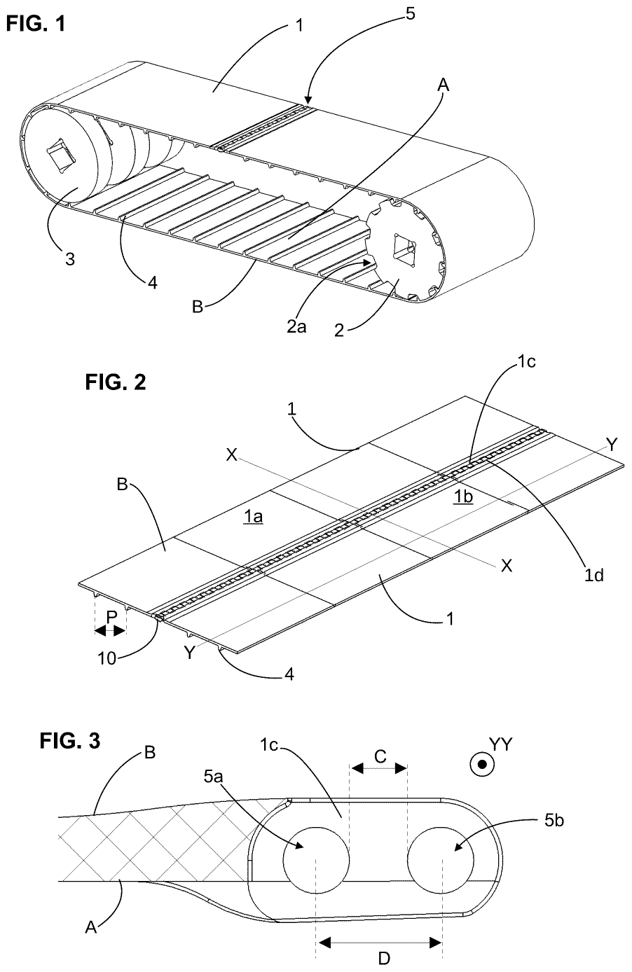

FIG. 1 illustrates a conveyor equipped with a conveyor belt 1 driven in movement by means of a drive device partially represented by a first wheel 2 that is a drive wheel and a second wheel 3 that can be a drive wheel or an idler wheel. Driving of the conveyor belt 1 by the first wheel 2, and by the second wheel 3 if this is the case, can be obtained by a plurality of teeth 4 that form transverse cross-members. The teeth 4 extend mainly in a transverse direction YY corresponding to the width of the conveyor belt 1. Drive wheel 2 is connected to a motor and is preferentially a cog-wheel equipped with teeth 2a. The teeth 4 of the conveyor belt 1 are repeated with a repetition pitch P in the longitudinal direction XX.

The conveyor belt 1 is an openable conveyor belt and is provided with a closing device 5. FIGS. 1 and 2 illustrate a conveyor belt 1 in the closed state whereas FIG. 9 illustrates a conveyor belt 1 in the open state.

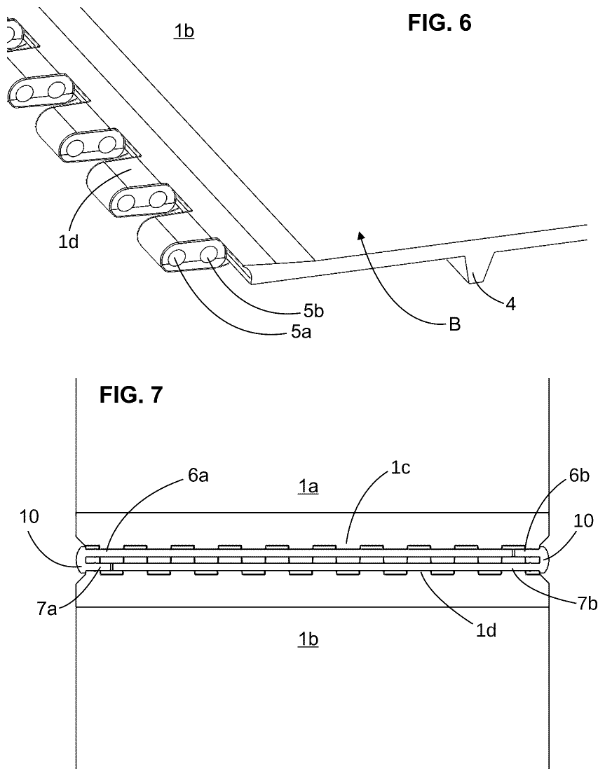

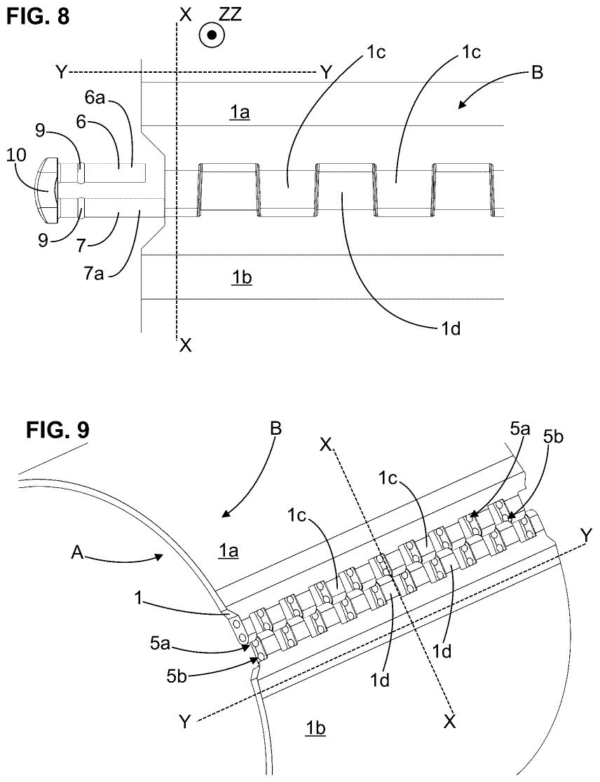

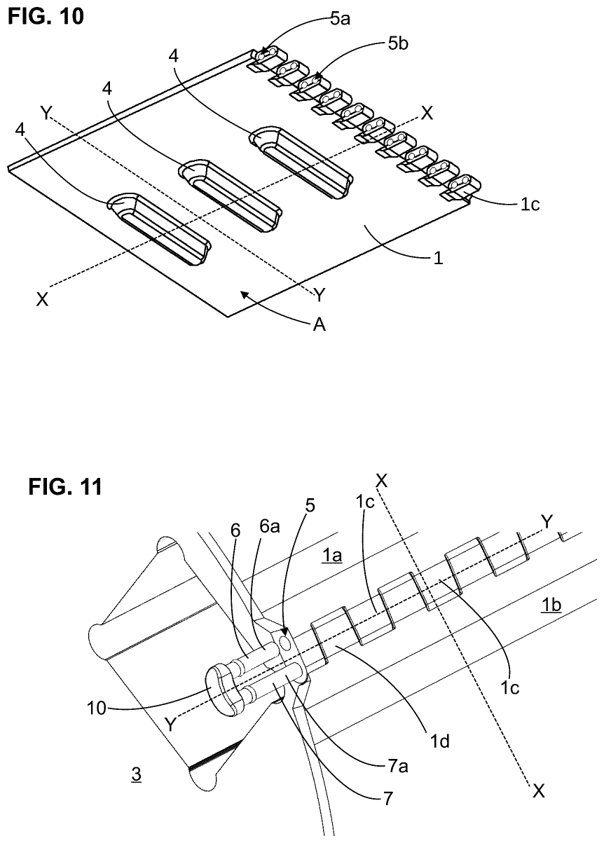

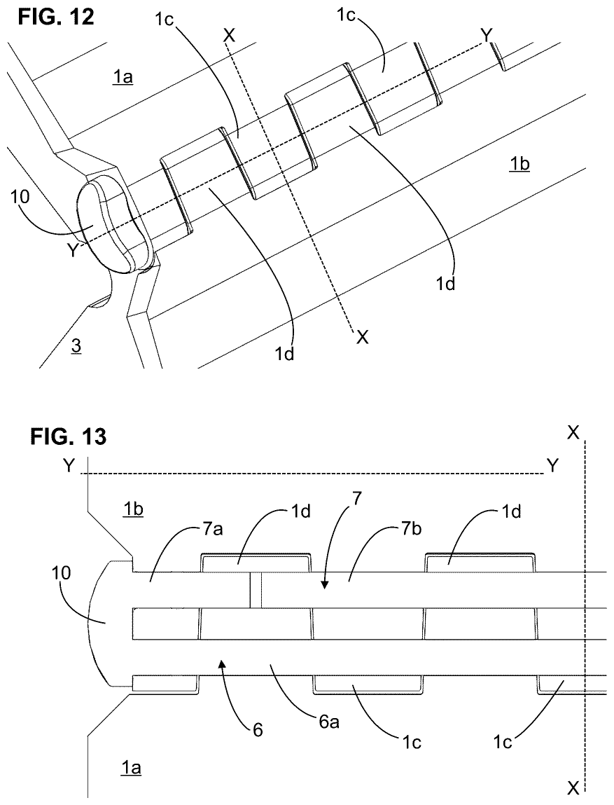

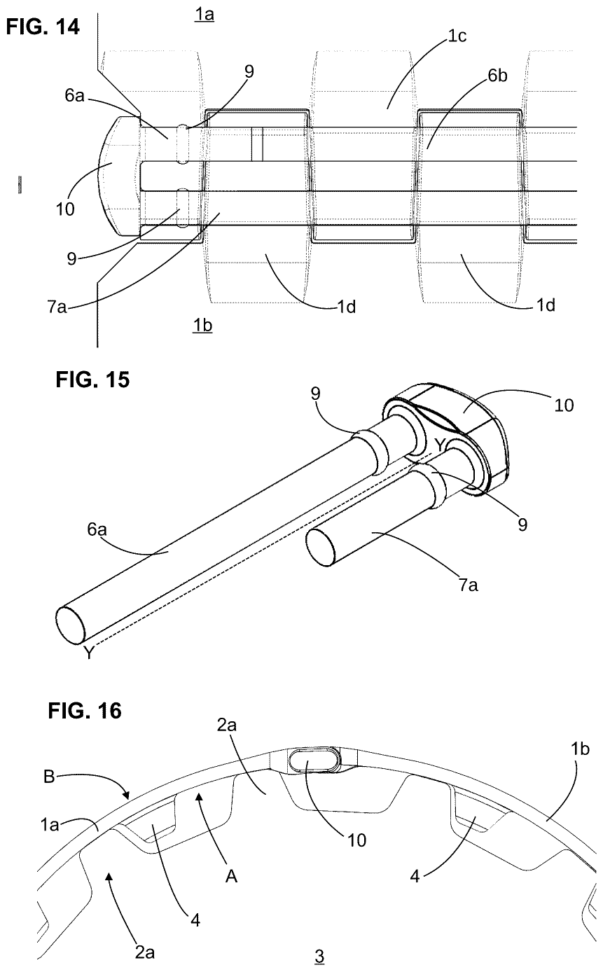

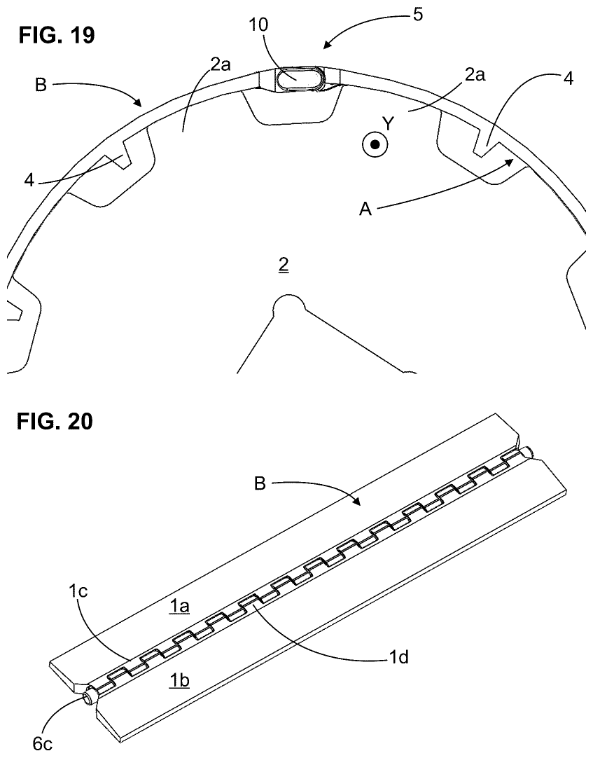

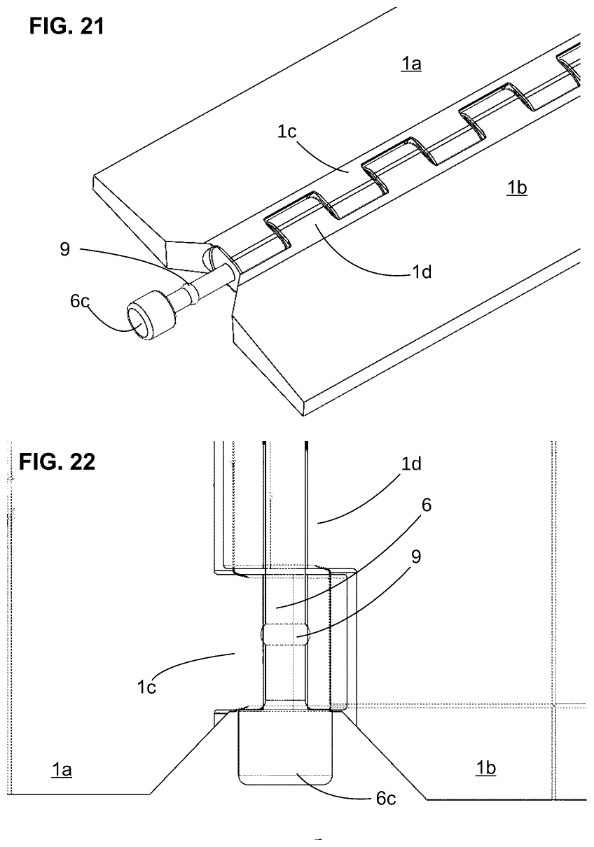

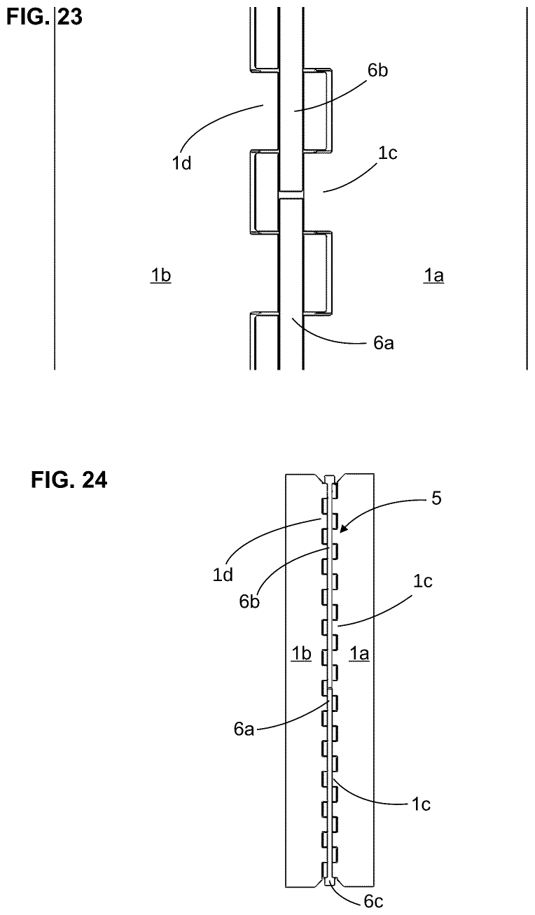

As illustrated in FIGS. 1 to 25, the closing device 5 of the conveyor belt 1 comprises a first end 1a and a second end 1b. The first end 1a defines a plurality of first clips 1c and the second end 1b defines a plurality of second clips 1d. The first clips 1c are salient in the longitudinal direction XX thereby forming an alternation between salient areas and recesses as illustrated in FIG. 10. The second clips 1d are salient in the longitudinal direction XX thereby forming an alternation between salient areas and recesses as illustrated in FIG. 6.

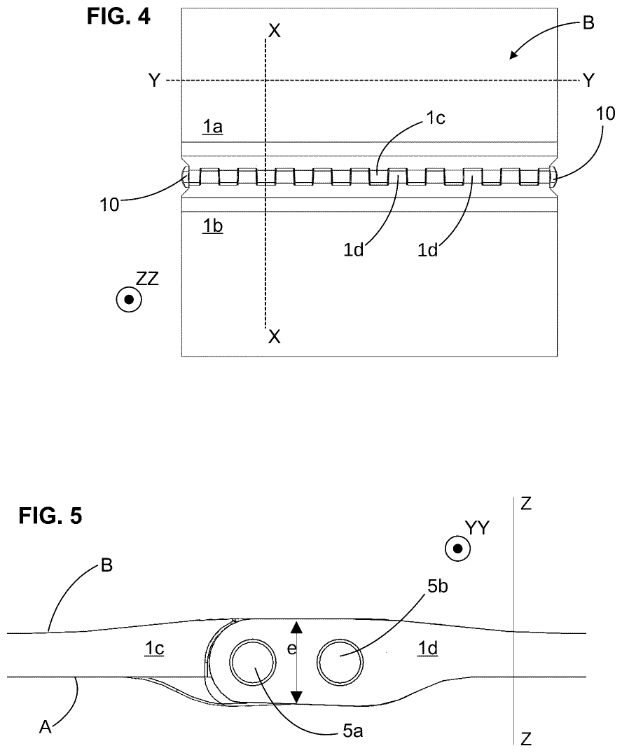

To close the conveyor belt 1, the first clips 1c are inserted between the second clips 1d and vice versa. In the closed position of the conveyor belt 1, there is an alternation between the first clips 1c and the second clips 1d in the transverse direction YY, as illustrated in FIGS. 4, 7 and 11 to 14. When the conveyor belt 1 is closed, the conveyor belt 1 defines a ring. The conveyor belt 1 has an inner face A and an outer face B that are opposite one another in the ZZ direction that defines the thickness. When the conveyor belt 1 is open, the first end 1a and the second end 1b are opposite one another in the longitudinal direction XX that is perpendicular to the transverse direction YY and perpendicular to the thickness direction ZZ.

As illustrated in FIGS. 3, 5, 6, 9, 10. 11, 13 and 14, the first clips 1c and the second clips 1d each define a first series of holes 5a and a second series of holes 5b. The holes of the first series of holes 5a are offset from the holes of the second series of holes 5b in the longitudinal direction XX. When the conveyor belt 1 is closed, the holes of the first series of holes 5a of the first end 1a and of the second end 1b are aligned alternately behind one another in the transverse direction YY to form a first through hole that extends over the whole width of the conveyor belt 1. When the conveyor belt 1 is closed, the holes of the second series of holes 5b of the first end 1a and of the second end 1b are aligned alternately behind one another in the transverse direction YY to form a second through hole that extends over the whole width of the conveyor belt 1. It is advantageous for the holes to be of circular cross-section for ease of insertion.

A first pin 6 is inserted in the first series of holes 5a to close the conveyor belt 1 and secure the first end 1a with the second end 1b. A second pin 7 is inserted in the second series of holes 5b to close the conveyor belt 1 and secure the two ends. The first pin 6 and the second pin 7 pass through the first series of holes 5a and the second series of holes 5b to secure the two ends. The first pin 6 is offset from the second pin 7 in the longitudinal direction XX of the conveyor belt 1. When the conveyor belt 1 is open, the conveyor belt 1 is of substantially rectangular shape. The longitudinal direction XX is the direction of the largest dimension. The longitudinal direction XX is perpendicular to the transverse direction YY. The length is larger than the width that is larger than the thickness. The pins 6 and 7 extend over the whole width so as to form a fastening between all the first clips 1c and the second clips 1d. The first pin 6 and/or the second pin 7 are preferably installed removable with respect to the first end 1a and second end 2b.

FIGS. 1, 2, 4, 7, 8, 11, 12, 13, 14 and 16 to 24 illustrate a closing device 5 in a position closing the conveyor belt 1. The first clips 1c and the second clips 1d are arranged alternately in the transverse direction YY and the pins 6 and 7 pass alternately through the first clips 1c and the second clips 1d to secure the two ends to one another. In preferential manner, the first pin 6 has a circular cross-section with a first diameter. It is also advantageous for the second pin 7 to have a circular cross-section with a second diameter. In even more advantageous manner, the first diameter is equal to the second diameter.

To form a closing device having a mechanical behaviour in the closed position that is closer to that of the rest of the conveyor belt, it is advantageous to provide a closing device that prevents rotation of the first end 1a with respect to the second end 1b. It is also advantageous to provide a simple configuration to facilitate assembly and closing of the conveyor belt 1. It is further advantageous to endeavour to provide a configuration that allows the use of first clips 1c and second clips 1d having simple shapes to make cleaning of the closing device 5 easier to perform.

To prevent rotation of the first end 1a with respect to the second end 1b, it is advantageous to use a first pin 6 and a second pin 7 installed in two distinct holes offset in the longitudinal direction XX.

However, although the use of two pins makes it possible to limit or even prevent rotation of the clips of the closing device respect to one another, it is observed that the lack of strength resulting from the configuration of the closing device itself means that gaps open up when a full rotation of the conveyor belt takes place, which is conducive to matter being retained on the closing device and may lead to bacterial proliferation. Contrary to expectations, it was observed that locally increasing the strength of the closing device enables bacterial proliferation to be reduced by limiting the appearance of gaps without rendering management of running of the closing device along wheels 2 and 3 too complicated.

To increase the strength of the closing device 5 locally in the closed position without increasing the size thereof, it is advantageous to have a separating distance D between the central axis of the first pin 6 and the central axis of the second pin 7 that is less than four times or three times the mean diameter of the first pin 6 and the second pin 7. This in particular enables the area located between the two pins to be strengthened. When the pin 6/7 is of circular cross-section, the central axis corresponds to the centre of the circle. When the cross-section of the pin is different from a circle, the central axis follows the centre of gravity of the different cross-sections perpendicularly to the YY direction. The mean diameter corresponds to the sum of the first diameter and the second diameter, the resulting sum being divided by two.

When the distance between the central axes of the first pin 6 and of the second pin 7 becomes too great, a large sagging of the closing device 5 is observed and the mechanical behaviour of the closing device 5 is more difficult to manage when the closing device 5 runs along a first wheel 2 or a second wheel 3.

As illustrated in FIG. 4, it is particularly advantageous for the separating distance D to be less than four times the mean diameter of the first pin 6 and the second pin 7 and even more preferentially less than three times the mean diameter of the first pin 6 and the second pin 7 or even equal to twice the mean diameter of the first pin 6 and the second pin 7.

In advantageous manner, the first clips 1c of the first end 1a and the second clips 1d of the second end 1b have a simple shape, for example a rectangular, square, semi-circular, or semi-ovoid cross-section. In preferential manner, the first clips 1c and the second clips 1d have a termination in the XX direction with a convex shape, i.e. curved outwards. The use of a simple, preferably convex, shape makes cleaning of the clip easier to perform. The use of a shape not presenting any concavity or presenting a concavity with a small radius of curvature makes cleaning of the closing device 5 easier to perform and prevents proliferation of bacteria when the conveyor belt 1 transports foodstuffs.

It is particularly advantageous to have a first end 1a with first clips 1c that are terminated by an arc of a circle connecting the inner face A and the outer face B. The second end 1b has a concave surface in the form of an arc of a circle of complementary shape to the terminal portion of the first clips 1c. The same is advantageously the case for the second clips 1d and for the facing portions of the first end la, i.e. between the opposite clips. The use of an arc of a circle of opposite polarity makes it easier to clean between the clips. The two complementary shapes facilitate cleaning. Preferentially, the radius of curvature of the arc of a circle is smaller than the distance between the terminal wall of the clip defining the arc of a circle and the centre of the nearest through hole.

Preferentially, the first pin 6 is separated from the second pin 7 by a distance C less than twice the mean diameter of the first pin 6 and the second pin 7, more preferentially less than 1.5 times the mean diameter of the first pin 6 and the second pin 7. Even more preferentially, the first pin 6 is separated from the second pin 7 by a distance C greater than or equal to 0.5 times the mean diameter of the first pin 6 and the pin 7 and even more preferentially greater than or equal to 0.75 times the mean diameter of the first pin 6 and the second pin 7 or greater than once the mean diameter of the first pin 6 and the second pin 7. When the distance C is less than 0.5 times the mean diameter, this can result in an impairment of the mechanical performances. Moving the first pin 6 and the second pin 7 towards one another unexpectedly results in an increase of the mechanical strength without an apparent impairment of the tear strength. This configuration is more advantageous than a single thicker pin or two thicker pins located farther from one another.

In a particularly advantageous embodiment, the two pins 6 and 7 have a circular cross-section with a diameter equal to a first value, and the two pins 6 and 7 are separated by a distance equal to the first value.

The use of a pin or of each pin having a circular cross-section makes it easier to insert the pins in the series of holes that have complementary shapes, i.e. holes of circular cross-section with a substantially identical diameter to that of the pins. As the pins and holes have substantially identical cross-sections, the first end can be secured efficiently with the second end resulting in the mechanical behaviour of the fastening area being closer to that of the rest of the conveyor belt.

By moving the first pin 6 and the second pin 7 towards one another and adjusting the ratio between the diameter of the pins and the thickness of the clips, the closing device can be strengthened without greatly increasing the size of the closing device 5.

The use of two pins 6 and 7 offset in the XX direction to secure the clips enables rotation of the two clips with respect to one another to be limited or even prevented. However, this configuration does not prevent the presence of undesired mechanical behaviours at the ends of the clips. It is then sought to form a hard point between the two pins and advantageously slightly around the two pins so that the clips hardly deform during the rotation phases to avoid freeing areas that are difficult to access and therefore conducive to bacterial proliferation.

By using two pins that connect the two clips, rotation of the clips with respect to one another is prevented. By increasing the thickness of the clips with respect to the rest of the conveyor belt, the strength of the closing device 5 in the closed position can be increased to approach or even exceed the strength of the rest of the conveyor belt.

The use of clips 1c and 1d that are thicker than the rest of the conveyor belt 1 enables the closing device 5 to be strengthened to obtain a behaviour closer to that of the rest of the conveyor belt 1. Using clips 1c and 1d with a thickness smaller than or equal to twice the thickness of the rest of the conveyor belt 1 in association with pins 6 and 7 that are closer to one another enables a closing device 5 to be formed having a mechanical behaviour close to or identical to that of the rest of the conveyor belt 1. Doubling of the thickness between clips 6 and 7 and the rest of the conveyor belt 1 can be managed by the equipment associated with the conveyor belt 1, for example a scraper 8 that is arranged to scrape the outer face B. This technical solution is particularly advantageous as it is simple to implement while at the same limiting the size of the closing device 5.

Advantageously, the mean thickness of the first clips 1c and the thickness of the second clips 1d are both less than or equal to twice a mean thickness of the conveyor belt 1 and at least 10% greater than the mean thickness of the conveyor belt 1. The mean thickness is calculated from one end to the other in the XX direction without taking account of the teeth 4 designed for driving the conveyor belt 1, if present.

It is preferable for the thicknesses of the first clips 1c and the second clips 1d to be constant or substantially constant at least from one end of first hole 5a to the opposite end of second hole 5b. The ends correspond to the opposite ends the farthest apart in the XX direction. More preferentially, the thickness is constant and equal to twice the mean thickness of the conveyor belt outside the first and second clips.

In order to have a mechanical behaviour of the closing device 5 performing closing of the conveyor belt 1 that is close to that of the rest of the conveyor belt, it is advantageous to limit the length of the clips. It is preferable for the first clips 1c and the second clips 1d to extend over a distance smaller than or equal to five or six times the mean diameter of the first pin 6 and the second pin 7 in a longitudinal direction XX of the conveyor belt 1. It is advantageous to have clips with a length that is less than four times or three times the separating distance between the central axes of the pins 6 and 7, i.e. the distance D. It is also preferable for the clips to present a length that is less than 10 times the mean thickness of the clips, advantageously less than 5 times the mean thickness of the clips.

The length is calculated as being the dimension salient from the lateral face in the XX direction, i.e. the overlap length between the first clips 1c and the second clips 1d. Limiting the length of the clips in this way makes it possible to use thin clips, for example clips with a mean thickness that is less than three times the thickness of the rest of the conveyor belt 1, or even less than or equal to twice the thickness of the rest of the conveyor belt 1. The clips have a thickness at least equal to the rest of the conveyor belt 1, i.e. between the first end 1a and the second end 1b outside the closing device 5. The thickness is measured ignoring the teeth 4 if present. As the surface occupied by the closing device 5 with respect to the conveyor belt 1 is small, the mean thickness of the conveyor belt 1 (not taking account of possible the teeth 4) can approach the thickness of the rest of the conveyor belt 1.

To increase the strength of the closing device 5, it is preferable for the increased thickness of the clip to extend beyond the overlap area over a distance that is smaller than the overlap area. It is preferable for the thickness to increase continuously up to the beginning of the salient portion in the XX direction and even more preferentially without reaching the height of the through holes in the ZZ direction. The overlap area is the overlap area between clips 1c and 1d in the YY direction.

By increasing the strength of the closing device 5, the stresses applied on the pins are increased. In order not to subject the pins that connect the clips to a too high shear stress, it is advantageous to increase the width of the clips. It is preferable to have first clips and second clips having a width that is more than twice the mean diameter of the first pin 6 and the second pin 7, preferably more than 2.5 times or three times greater. The width is measured in the YY direction. With the use of fastening with two pins, the repetition pitch of the clips is able to be increased.

To provide a closing device 5 having a strength that is closer to that of the rest of the conveyor belt, it is preferable to have first clips and second clips with a width that is more than twice the mean thickness of the conveyor belt, more preferentially more than three times the mean thickness of the conveyor belt.

More preferentially, the width of the first clips and the second clips is more than twice the mean diameter of the first and second pins and more than twice the mean thickness of the conveyor belt in order to reduce the shear stresses on pins 6 and 7.

Advantageously, the conveyor belt 1 is made from polymer material, preferably from a single material, for example from polyurethane. It is particularly advantageous to form the closing device 5 in monolithic manner with the rest of the conveyor belt 1 except for the pins.

It is advantageous for the first pin 6 to be made from metal or from a polymer material. When the first pin 6 is made from polymer material, it is preferable for the first pin 6 to be made from the same material as that of the conveyor belt 1. It is also advantageous to choose a material that has a Young's modulus that is equal to or higher than that of the material forming the rest of the conveyor belt, preferably the clips. With such materials, it is possible to form pins that strengthen the closing device. The second pin 7 is preferentially made from the same material as the first pin 6.

In preferential manner, the mean thickness of the conveyor belt 1 between the first pin 6 and the second pin 7, i.e. the thickness of the first clips 1c and the second clips 1d, is less than three times the mean diameter of the first pin 6 and the second pin 7. In preferential manner, the mean thickness of the first clips and the second clips is comprised between 1.5 times and 2.5 times the mean diameter of the first pin 6 and the second pin 7, preferentially equal to twice the mean diameter of the first pin 6 and the second pin 7. Such a configuration enables a good strengthening of the closing device 5 to be had without greatly increasing the size of the closing device 5. The mean thickness is measured in the part salient in the XX direction.

It is particularly advantageous for the mean diameter of the pins 6 and 7 to be at least equal to half the mean thickness of the conveyor belt 1 between the two ends and outside the closing device, more preferentially at least equal to 0.75 times the mean thickness or even more than or equal to the thickness of the conveyor belt between the two ends and outside the closing device. It is advantageous for the thickness not to be more than 1.25 times the mean thickness of the conveyor belt 1 between the two ends and outside the closing device 5.

In an advantageous embodiment, the diameter of the first pin 6 and the diameter of the second pin 7 are more than 0.5 times the mean thickness of the conveyor belt 1 measured from one end to the other in the longitudinal direction XX of the conveyor belt 1 and from one end to the other in the transverse direction YY of the conveyor belt 1. Preferentially, the diameter of the first pin 6 and the diameter of the second pin 7 are more than 0.75 or 0.8 times the mean thickness of the conveyor belt 1. The mean thickness is measured without the teeth 4 if present. It is advantageous for the diameter of the pins 6 and 7 not to be too small in order not to weaken the pins. By using pins with diameters that are close to the mean thickness of the conveyor belt, pins can be formed having a mechanical strength that is compatible with the stresses to which the conveyor belt 1 is subjected without increasing the size of the closing device 5.

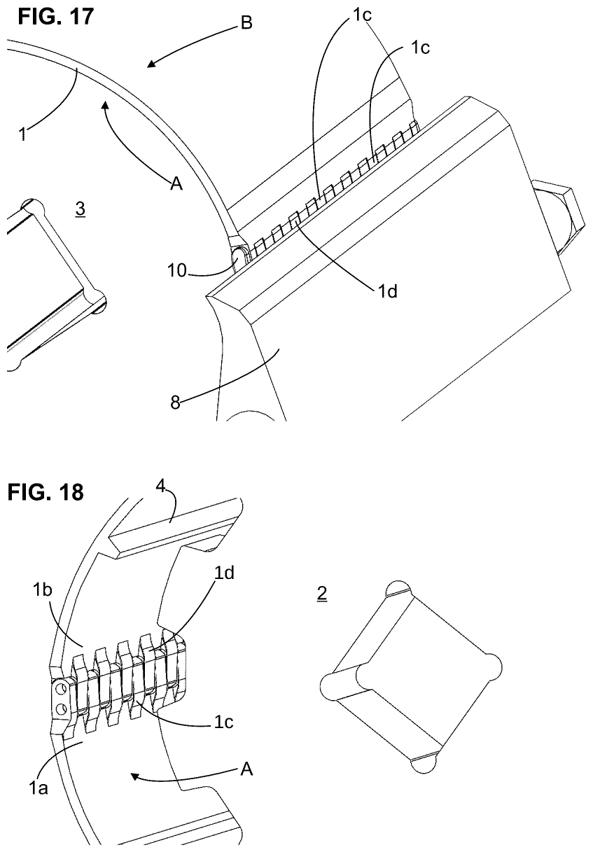

It is also advantageous for the diameter of the first pin 6 and the diameter of the second pin 7 to be less than 1.5 times the mean thickness of the conveyor belt 1 measured from one end to the other in the longitudinal direction XX of the conveyor belt 1 and from one end to the other in the transverse direction YY of the conveyor belt 1. This avoids forming a closing device 5 that is too thick. When the closing device is too thick, use of the conveyor belt is more difficult as the extra thickness modifies the behaviour of the closing device 5 with respect to the rest of the conveyor belt 1. This also complicates the drive mechanism of the conveyor belt and/or the use of a scraper 8 designed to scrape the outer face B of the conveyor belt. FIG. 17 illustrates an embodiment with a scraper 8 that presses on the outer face B of the conveyor belt 1.

In advantageous manner, the closing device 5 serving the purpose of securing the first end 1a with the second end 1b represents an area with a mean thickness that is greater than or equal to the mean thickness of the conveyor belt 1 outside the closing device 5 and not taking account of the teeth 4 if present. The increased thickness strengthens the area situated between the two pins 6 and 7 so as to have a flexion that is closer to that of the rest of the conveyor belt 1.

In preferential manner, the first clips 1c and the second clips 1d are thicker than the rest of the conveyor belt 1 except for the teeth 4 if present. Preferentially, the first clips 1c and the second clips 1d present the same mean thickness and are arranged to form a first area the outer face of which is flat to facilitate cleaning of the closing device 5. The outer face of the clips can be offset outwards in comparison with the outer face B of the conveyor belt 1 outside the closing device 5. In preferential manner, the first clips 1c are salient from the inner face A of the conveyor belt 1. Such an embodiment is illustrated in FIGS. 3 and 5 that illustrate clips approximately twice as thick as the rest of the conveyor belt 1, a part of the extra thickness being arranged salient from the outer face B and a part of the extra thickness being arranged salient from the inner face A in comparison with the conveyor belt 1 outside the closing device 5. In the particular embodiment illustrated in FIG. 3, the thickness of the clips increases and then decreases until the termination of the arc of a circle is reached. The thickness of the clip increases until one end of the hole is reached, and the thickness then decreases until the termination in the form of an arc of a circle is reached. The increase followed by the decrease of the thickness is observed in the longitudinal direction XX from the fixing area of the clip with the central part of the conveyor belt to the termination of the clip.

The first clips 1c are firmly secured to the conveyor belt. Increasing the thickness to form the first clips 1c results in the first end 1a being strengthened. The same is advantageously the case for the second clips 1d.

When the conveyor belt 1 is designed to engage a drive cog-wheel, it is advantageous for the first pin 6 and the second pin 7 to be arranged between two consecutive teeth 4. It is advantageous for the separating distance between the first pin 6 and the second pin 7 to be at least twice smaller than the repetition pitch P of the teeth 4, preferably at least three or at least four times smaller than the repetition pitch P of the teeth 4. The closing device 5 is preferably located equidistant between the two nearest the teeth 4. Advantageously, the closing device 5 takes the place of a tooth 4. It is preferable for the equidistant point of the two nearest teeth 4 to be situated in the space comprised between the first pin 6 and the second pin 7 in the ZZ direction.

The first pin 6 and/or the second pin 7 can extend continuously over the whole length of the through hole in the YY direction. It is advantageous for the first pin 6 and/or the second pin 7 to be flush with each of the side walls of the conveyor belt. It is preferable for the first pin 6 and/or the second pin 7 to protrude out slightly from the side walls in the YY direction.

In an advantageous embodiment illustrated in FIG. 7, the first pin 6 is formed in two parts with a first part 6a that has an end-of travel stop pressing on a first side of the conveyor belt 1 and a second part 6b that has an end-of travel stop pressing on a second side of the conveyor belt 1. The first side and the second side are located on one side and the other of the conveyor belt 1 in the transverse direction YY, i.e. along the lateral dimension. The use of a first pin 6 in two parts makes installation of the first pin 6 easier to perform. The end-of-travel stop determines the maximum depression of each of the first part 6a and the second part 6b in the first through hole. Preferentially, each end-of travel stop 6c forms a button defining a continuous annular contact area with a lateral face of one of the first and second clips 1c, 1d around the two ends of the first through hole. Advantageously, the thickness of the end-of travel stop 6c is at least 10% larger than the first diameter.

In particular manner, the end of the first part 6a presses on the end of the second part 6b. Advantageously, the end of the first part 6a and the end of the second part 6b join up inside one and the same first clip 1c. In an advantageous embodiment illustrated in FIG. 7, the end of the first part and the end of the second part terminate inside a single clip defining an empty space. These embodiments are advantageous as this makes it possible to have all the through holes completely sealed off and provides a good mechanical strength.

The same is advantageously the case for the second pin 7.

Preferentially, when the first pin 6 and/or the second pin 7 are formed in two parts with a first part 6a, 7a that has an end-of travel stop 6c, 7c pressing on a first lateral side of the conveyor belt 1 and a second part 6b, 7b that has an end-of travel stop 6c, 7c pressing on a second lateral side of the conveyor belt 1, the first part 6a terminates in one of the first clips 1c and the second part 6b terminates in said one of the first clips 1c.

Adjustment of the depression depth of the first pin 6 inside the first series of holes 5a can be formed by an end-of travel stop 6c illustrated in FIG. 20 with a closing device having a single pin. The end-of travel stop 6c has a width preventing the latter from entering the first series of holes 5a. It is advantageous for the end-of travel stop 6c to press continuously in annular manner on the lateral face. Such a stop configuration reduces or even prevents foodstuffs from entering the outlet of the first series of holes 5a that open out in the side wall of the conveyor belt 1.

When the first pin 6 is formed in two parts 6a and 6b with both parts terminated by an end-of travel stop 6c and both parts terminating inside one of the clips, the first pin 6 makes it more difficult for foodstuffs to get stuck along the first series of holes 5a. The same is advantageously the case for the second pin 7 provided with a stop.

It is particularly advantageous to use a first pin 6 and the second pin 7 that are both made up in two parts. It is also advantageous for the first clip 1c that receives the first part 6a and the second part 6b of the first pin 6 to be located in a first half of the conveyor belt and for the first clip 1c or the second clip 1d that receives the first part 7a and the second part 7b of the second pin 7 to be located in a second half of the conveyor belt 1. The first half and second half are separated by a median longitudinal plane that is perpendicular to the transverse direction YY.

In an advantageous embodiment illustrated in FIGS. 2, 4, 7, 8, 11 to 17, the first pin 6 is secured to the second pin 7 by means of a strengthener 10. The strengthener 10 connects the first pin 6 to the second pin 7. The assembly formed by the first pin 6, the second pin 7 and the strengthener 10 preferentially defines a monolithic part, i.e. that is not able to be disassembled. The strengthener 10 has a thickness that is larger than the mean diameter of the first pin 6 and of the second pin 7. It is advantageous for the width of the strengthener 10 to be less than or equal to the thickness of the first clips 1c and the second clips 1d. The thickness of the strengthener 10 is measured in the ZZ direction that passes through the outer face B and the inner face A. In even more advantageous manner, the thickness of the strengthener 10 is less than or equal to the thickness of the conveyor belt over the whole of the facing distance between the strengthener 10 and the conveyor belt in the YY direction. The strengthener 10 does not extend beyond the plane formed by the outer face B of the closing device, or beyond the inner face A.

Preferentially, the strengthener 10 is made from the same material as the first pin 6 and the second pin 7, from metal or from any material that has a Young's modulus that is higher than or equal to that of the material forming the closing device and preferentially the clips.

The distance between the first pin 6 and the second pin 7 is smaller than the repetition pitch of the teeth 4. In preferred manner, the first pin 6 and the second pin 7 are arranged in a space between two consecutive teeth 4. This configuration is more advantageous than a configuration where the first pin 6 and the second pin 7 are separated by a tooth 4. Advantageously, the repetition pitch P of the teeth 4 is greater than or equal to three times the distance D between the central axes of the first pin 6 and the second pin 7, preferentially greater than or equal to five times and even more preferentially greater than or equal to ten times the distance D between the central axes of the first pin 6 and the second pin 7.

In even more preferential manner, the minimum distance between a tooth 4 and a pin 6/7 is greater than or equal to three times the distance D between the central axes of the first pin 6 and the second pin 7. Advantageously, the assembly formed by the first pin 6 and the second pin 7 is located at equal distance from two teeth 4 in the XX direction. Preferably, the tooth 4 the closest to the first clips 1c is separated from the first clips 1c by a distance greater than three times the mean distance of the diameter of the first pin 6 and the second pin 7. This makes it easier to obtain a behaviour of the closing device that is closer to that of the rest of the conveyor belt.

In preferential manner, the mean thickness of the first clips 1c is equal to the thickness of the second clips 1d. More preferentially, once the first end 1 has been secured to the second end 2, the securing area presents a flat outer surface. Advantageously, the thickness of the first clips 1c and the second clips 1d is decreasing at least from one end of the first hole to the opposite end of the second hole respectively in a longitudinal direction starting from a central portion of the conveyor belt 1 and directed towards a termination of the first clips 1c and the second clips 1d. The thickness is equal to twice the mean thickness of the conveyor belt outside the first and second clips.

In an advantageous embodiment, the first pin 6 has a blocker 9 that is an elastically deformable area. The blocker 9 is arranged salient so as to increase the friction between the first pin 6 and at least one of a first clip 1c or a second clip 1d. FIGS. 7, 8, 11, 14 and 15 illustrate a first pin 6 and a second pin 7 that are each provided with a protrusion. The protrusion forms the blocker 9 that increases the cross-section of the pin locally to make depression and especially extraction of the latter more difficult. It is preferable to form the blocker 9 close to the end-of travel stop to facilitate insertion of the pin over the whole length of the pin. Preferably, when the pin is installed, the blocker 9 is wedged in the clip nearest the end-of travel stop or the complete clip nearest the end-of travel stop.

It is particularly advantageous to form a conveyor belt 1 comprising a closing device 5 according to any one of the above configurations. It is also advantageous to form a conveyor using a conveyor belt 1 comprising a closing device 5 according to any one of the above configurations.

In addition to the issues relating to mechanical management of the closing device 5 configured to secure the first end 1 with the second end 2, it is preferable for the closing device 5 not to be the cause of bacterial proliferation. It is commonplace for matter to remain stuck in the gaps of the closing device 5 and in particular in the pin 6/7 that secures first end 1 with second end 2. This problem is all the more difficult to manage as the length of the pin 6/7 has to be adjusted to suit the width of the closing device 5. When the pin 6/7 is too short, the through hole forms a cavity the bottom of which is formed by the pin 6/7 and that is liable to retain matter. This matter that is difficult to access will give rise to proliferation of bacteria. When the pin 6/7 is too long, it makes driving of the conveyor belt 1 more difficult as the pin 6/7 may catch in equipment located in the proximity of the conveyor belt 1. A requirement therefore exists to improve management of cleaning of the closing device 5.

To achieve this result, it is particularly advantageous to provide a pin 6/7 that has a termination formed by an area of larger cross-section forming a continuous annular contact surface around the first hole or the second hole designed to receive the pin 6/7. It is complicated to have a pin 6/7 with a cross-section that is perfectly identical to the cross-section of the through hole. Installation of the pin 6/7 is more difficult as the available space is small. The separating distance then allows matter to enter between the pin 6/7 and the edge of the through hole. It is therefore particularly advantageous to have a pin end that forms a plug continuously in contact with the side wall of the conveyor belt 1. The plug prevents access to the through hole.

In one embodiment, the hole of the closing device 5 present in the first end 1a is not a through hole. It is advantageous to have a plug that forms an end-of travel stop 6c so that the first pin 6 stops in the immediate proximity to the bottom of the hole, inside the last clip.

In another embodiment, the at least one hole of the closing device 5 is a through hole, and it is then advantageous for the first pin 6 to be formed in two parts 6a and 6b and for the two parts 6a and 6b to be provided with a plug having a continuous annular contact with the side walls of the conveyor belt 1. A plug is then present at each of the ends of the first pin 6 to prevent matter from entering between the first pin 6 and the side wall of the hole.

It is advantageous for the plug to have a thickness that is less than or equal to the thickness of the clips. The thickness is measured in a ZZ direction that cuts the outer face B and the inner face A of the conveyor belt 1. This avoids forming a privileged catching area salient from the conveyor belt 1, for example a scraper 8.

Depending on the embodiments, the closing device 5 can have only a first pin 6 or several pins, preferably the first pin 6 and the second pin 7. When the closing device 5 has several pins, it is advantageous for each of the pins 6/7 to have at least one end-of travel stop in the form of an annular plug extending continuously around the first through hole on the side wall of the closing device 5. FIGS. 20. 21, 22 and 23 illustrate an embodiment with a single pin. This embodiment is less efficient than that presented beforehand to form a closing device having a mechanical behaviour that is closer to the mechanical behaviour of the rest of the conveyor belt 1. Such an embodiment does however procure a better resistance to bacterial proliferation.

The annular plug 6c defines a continuous annular contact with the side wall of one of the clips, here a first clip 1c, so as to prevent impurities from entering and being retained in the through hole or the joint between the pin and through hole. It is sought to form a pin having a cross-section that is as complementary as possible to the cross-section of the holes formed in the clips. However, with manufacturing uncertainties and with wear, a slight gap may form. This gap is known to be an area favourable for bacterial development as it is difficult to clean.

It is therefore advantageous to form an annular plug that is in contact with the side wall and that limits or even prevents access to the end of the through hole.

To limit bacterial proliferation, it is advantageous to use a pin formed in two parts each of which parts is terminated by an annular plug. In this way, the two ends of the through hole are sealed off by two plugs that press on a clip. As indicated in the foregoing, it is preferable preferable for the two ends of the two parts of the pin to join up in the same clip. All the through holes are sealed off by one or the other of the two parts of the pin thereby limiting or even preventing entry of impurities in the through holes of the clips. As illustrated, the shapes of the clips and of the recesses are as complementary as possible to prevent matter from entering between the clips. By using simple shapes and one or more removable pins, it becomes easy to open the conveyor belt and to clean the latter.

When the closing device 5 has a first pin 6 and a second pin 7, it is advantageous for the plugs of two adjacent pins to belong to one and the same monolithic part that preferentially forms a strengthener 10 as illustrated in FIGS. 15, 21 and 22. Each of the two plugs forms an annular contact surface with the side wall of the first or last clip to prevent access to the through hole.

When the two inner ends of the first pin 6 are located in the same clip, it is very difficult for matter to get in between the two parts of the pin. To facilitate installation of the parts of the pin, it is advantageous to form a free space in the through hole of the clip that is less than 50% of the dimension of the clip in the YY direction, preferably less than 25%. Advantageously, each of the parts of the first pin 6 extends inside the clip over a distance at least equal to 10%, preferably at least equal to 20%, more preferentially at least equal to 30% of the width of the clip. The greater the depression distance of each of the parts of the first pin, the lower the risk of detachment. This makes it possible to avoid forming a flexible point or a flexibility area.

Preferentially, when the closing device has only a first pin 6, the clip receiving the end of the first part and the end of the second part is located in a central third in a transverse direction YY.

In a particular embodiment, the first pin 6 and the second pin 7 are both formed in two parts. It is particularly advantageous for the clip receiving the end of the first part and the end of the second part of the first pin 6 to be different from the clip receiving the end of the first part and the end of the second part of the second pin 7. Differentiating the clips enables the stresses to be spread better. It is preferable for the two clips receiving the ends of the first pin 6 and of the second pin 7 to be separated by at least 5%, preferably at least 10%, of the width of the closing device in the YY direction. In a particular embodiment, the clip receiving the end of the first part and the end of the second part of the first pin 6 is located in a first third in the transverse direction YY and the clip receiving the end of the first part and the end of the second part of the second pin 7 is located in a third third in the transverse direction YY.

The plug is preferably installed irremovable from the rest of the pin.

In another embodiment, the pin or each part of the pin is provided with a blocker 9 configured to block the position of the pin in the transverse direction YY when the pin is subjected to a stress in the transverse direction YY that is lower than a threshold value. When the pin is inserted in the hole, the pin is inserted with a force that is greater than the threshold value. When the conveyor belt 1 moves, the pins are subjected to stresses a part of which is expressed by a force in the transverse direction YY. The use of the blocker 9 enables the pin to be held in position when the conveyor belt 1 rotates.

In a particular embodiment, the closing device defines an indentation in each of its side walls in the YY direction. The indentation corresponds to a narrowing of the width of the terminal clip so that the plug is not installed salient with respect to the rest of the conveyor belt in the YY direction.

1-13. (canceled)

14. A conveyor belt for foodstuffs comprising:
a first end and a second end of a conveyor belt respectively defining first clips and second clips, the first clips and the second clips each defining a first series of holes and a second series of holes, wherein in a closed position of the conveyor belt, the first series of holes are aligned to form a first through hole extending over a whole width of the conveyor belt and the second series of holes are aligned to form a second through hole extending over the whole width of the conveyor belt, and the first clips and the second clips are arranged alternately;
a first pin passing through the first series of holes to secure the first end and the second end, the first pin having a first diameter;
a second pin passing through the second series of holes to secure the first end and the second end, the second pin having a second diameter;
wherein the first pin and the second pin are removable with respect to the first end and the second end to form an openable conveyor belt, the second pin and the first pin being offset in a longitudinal direction of the conveyor belt, the first clips, the second clips, the first pin and second pin forming a closing device configured to close the conveyor belt;
wherein the first clips and the second clips have a mean thickness at least 10% greater than and less than twice a mean thickness of the conveyor belt outside the closing device, the mean thickness of the conveyor belt being calculated without taking account of any teeth designed for driving conveyor belt when the conveyor belt comprises the teeth;
in that a separating distance between a central axis of the first pin and a central axis of the second pin is less than three times a mean diameter of the first pin and of the second pin to locally strengthen an area located between the first pin and the second pin, the first pin being separated from the second pin by a distance less than twice the mean diameter of the first pin and the second pin;
in that both the first pin and the second pin are formed by means of a first part and a second part that each comprise an end-of travel stop defining a maximum depression of each of the first part and the second part in the first through hole and in the second through hole;
wherein each end-of travel stop forms a button salient from a side wall of the conveyor belt;
in that each button defines a continuous annular contact area with a lateral face of one of the first clips and the second clips around two ends of the first through hole and of the second through hole;
in that the end-of travel stop of the first part of the first pin is monolithic with the end-of travel stop of the first part of the second pin to form a strengthener having a thickness that is greater than or equal to the mean diameter of the first pin and of the second pin and smaller than a thickness of the first clips and second clips at least between the first pin and the second pin;
and in that, when the conveyor belt has a series of teeth arranged salient from an inner face and designed for driving the conveyor belt, the teeth being spaced apart with a repetition pitch, the first pin and the second pin are arranged between two consecutive teeth and the separating distance between the first pin and the second pin is at least twice smaller than the repetition pitch.

15. The conveyor belt according to claim 14, wherein the first clips and the second clips are terminated by a portion in the form of an arc of a circle, wherein the first end defines a shape complementary to the portion in the form of an arc of a circle of the second clips to receive the second clips and wherein the second end defines a shape complementary to the portion in the form of an arc of a circle of the first clips to receive the first clips, the shape of an arc of a circle being observed in a depression direction of the first pin and the second pin.

16. The conveyor belt according to claim 15, wherein the first clips and the second clips extend over a distance less than or equal to four times the separating distance in a longitudinal direction of the conveyor belt.

17. The conveyor belt according to claim 16, wherein a width of the first clips is more than 2.5 times the mean diameter of the first pin and the second pin.

18. The conveyor belt according to claim 16 wherein a thickness of the first clips and a thickness of the second clips are decreasing at least from one end of the first hole to an opposite end of the second hole respectively in a longitudinal direction starting from a central portion of the conveyor belt and directed towards a termination of the first clips and the second clips, and wherein each of the thicknesses is equal to twice the mean thickness of the conveyor belt outside the first and second clips.

19. The conveyor belt according to claim 14, comprising a series of teeth arranged salient from an inner face and designed to engage a cog-wheel to drive the conveyor belt in rotation, the teeth being spaced apart with the repetition pitch, wherein a tooth closest to one of the first pin and the second pin is separated from the one of the first pin and the second pin by at least three times the separating distance.

20. The conveyor belt according to claim 14, wherein a thickness of the end-of travel stop is at least 10% greater than the first diameter and smaller than a mean thickness of the first clip and the second clip.

21. The conveyor belt according to claim 14, wherein one predefined clip of the first clips and the second clips receives an end of the first part and an end of the second part of the first pin, wherein another predefined clip of the first clips and the second clips receives an end of the first part and an end of the second part of the second pin, the other predefined clip being different from the predefined clip.

22. The conveyor belt according to claim 21, wherein the first part of the first pin and the second part of the first pin define an empty area inside the predefined clip.

23. A method for closing an openable conveyor belt comprising:
providing a conveyor belt provided with a first end defining first clips with at least a first series of holes having a first diameter and a second series of holes having a second diameter and with a second end defining the second clips with at least a first series of holes having the first diameter and a second series of holes having the second diameter;
closing the conveyor belt, the first clips and the second clips forming an alternation wherein the first series of holes are aligned to form a first through hole extending over a whole width of the conveyor belt and the second series of holes are aligned to form a second through hole extending over the whole width of the conveyor belt;
inserting a first part of a first pin passing through the first series of holes and a first part of a second pin passing through the second series of holes to secure the first end and the second end, the first part of the first pin and the first part of the second pin being removable with respect to the first end and the second end;
inserting a second part of the first pin passing through the first series of holes and a second part of the second pin passing through the second series of holes to secure the first end and the second end, the second part of the first pin and the second part of the second pin being removable with respect to the first end and the second end, and wherein the second pin and the first pin are offset in a longitudinal direction of the conveyor belt, the first clips, the second clips, the first pin and the second pin forming a closing device configured to close the conveyor belt;
wherein the first clips and the second clips have a mean thickness at least 10% greater than and less than twice a mean thickness of the conveyor belt outside the closing device, the mean thickness of the conveyor belt being calculated without taking account of any teeth designed for driving conveyor belt when the conveyor belt comprises the teeth;
wherein a separating distance between a central axis of the first pin and a central axis of the second pin is less than three times a mean diameter of the first pin and of the second pin to locally strengthen an area located between the first pin and the second pin, the first pin being separated from the second pin by a distance less than twice the mean diameter of the first pin and the second pin;
wherein both the first pin and the second pin are formed by means of a first part and a second part that each comprise an end-of travel stop defining a maximum depression of each of the first part and the second part in the first through hole and in the second through hole;
wherein each end-of travel stop forms a button salient from a side wall of the conveyor belt;
wherein the end-of travel stop of the first part of the first pin is monolithic with the end-of travel stop of the first part of the second pin to form a strengthener having a thickness that is greater than or equal to the mean diameter of the first pin and of the second pin and smaller than the thickness of the first clips and the second clips at least between the first pin and the second pin;
wherein when the conveyor belt has a series of teeth arranged salient from an inner face and designed for driving the conveyor belt, the teeth being spaced apart with a repetition pitch, the first pin and the second pin are arranged between two consecutive teeth and the separating distance between the first pin and the second pin is at least twice smaller than the repetition pitch.
